(19) United States
(12) Patent Application Publication
(10) Pub. No.: US 2004/0146704 A1
(43) Pub. Date: Jul. 29, 2004

(54) Vehicular headliner and method for production thereof

(76) Inventor: Mohammad Hossein Zolfaghari, Windsor Ontario (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/432,671

(22) PCT Filed: Nov. 26, 2001
(86) PCT No.: PCT/CA01/01638

(51) Int. Cl. B32B 3/26

(52) U.S. Cl. 428/304.4

(57) ABSTRACT

A vehicular headliner comprising a molded foam element is described. The headliner comprises energy management capabilities to improve vehicle occupant safety. The headliner comprises an A-surface disposed to face an interior of a vehicle and a B-surface substantially opposed to the A-surface. The headliner includes a molded foam element having a substantially uniform density and an indentation force deflection at 25% deflection in the range of from about 150 pounds to about 4000 pounds when measured pursuant to ASTM 3574-B₁. The foam element comprises a peripheral portion, a non-peripheral portion and an intermediate portion disposed therebetween, the intermediate portion having a greater cross-sectional thickness than at least one of the peripheral portion and the non-peripheral portion. A process for producing the headliner is also described. A mold for producing the headliner is also disclosed.

### BACKGROUND OF THE INVENTION

1. Field of the Invention

In one of aspects the present invention relates to a headliner, more particularly a vehicular headliner. In another of its aspects, the present invention relates to process for the production of a headliner. In yet another of its aspects, the present invention relates to a mold useful for the production of a foam element, particularly a headliner, more particularly a vehicular headliner.

2. Description of the Prior Art

Vehicular headliners are generally known in the art. More particularly automotive headliners are generally known in the art.

As is known such automotive headliners are used to line the roof of the automobile. Conventionally, an automotive headliner is a laminate structure comprising, for example, a foam or other padded element having a cover material secured thereto. The cover material comprises a finished outer surface that faces the interior of the automobile and this the cover material is disposed adjacent or is comprised in the so-called A-surface of the headliner. The surface of the headliner adjacent the A-surface is the so-called B-surface. The B-surface of the headliner may or may not comprise a cover material.

Conventionally, foamed automotive headliners have made produced from isocyanate-based foams such as polyurethane foams.

When producing automotive headliners from polyurethane foams, it is conventional to utilize the so-called free-rise or slab polyurethane foams.

In a typical slab polyurethane foam production plant, the resultant foam is usually produced by dispensing a foamable composition into a trough having an open top (also known as a tunnel) and a conveyor bottom to move the composition away from the mixhead as the foam rises. Low pressure mixing is typically used and involves metering the components for foam production into a mixhead equipped with a stirrer (or other suitable agitation means) at a pressure generally less than 500 psi (usually 200-350 psi). The components are mixed in the mixhead and the foamable composition is expanded to produce polyurethane foam. As is known in the art, low pressure mixing is conventionally used to produce slabstock foam. It is known to vary the properties of the resulting foam by varying the nature and/or amount of one or more of the metered components.

Commercial slabstock polyurethane foam plants produce foam “buns” having dimensions such as 4 feet (height)×6 feet (width)×100 feet (length). Each bun is then cut into a plurality shorter length (e.g., 5 feet) buns, depending on the specifications of the particular automotive headliner being produced. The shorter length bun is then sliced into sheets of appropriate thickness (e.g., ½ to 1½ inches). Each sheet is then covered, trimmed and secured in the automobile. It is also known in the art to subject each sheet to further processing steps such as thermoforming so to confer to the planar sheet a slightly contoured appearance which more closely assumes the shape of the roof of the automobile.

Thus, slabstock polyurethane foam conventionally used in the production of automotive headliners is known as a foam (e.g., a resilient foam) having at least one uncontoured surface (i.e., the foam is a “free-rise” foam).

Regardless of the precise mode of production, an automotive headliner produced from slabstock foam suffers from the disadvantage of requiring many productions steps and resulting the in the production of relatively large amounts of scrap foam which can be difficult to discard.

U.S. Pat. Nos. 5,683,796 and 5,721,038 [both to Kornylo et al. (Kornylo)] teach a vehicular headliner made from molded polyurethane foam. The headliner taught by Kornylo purportedly comprises a substantially constant density while having central sections with a greater cross-sectional thickness than peripheral portions. The central sections must be relatively thick such that the headliner possesses acceptable sound absorbing properties while the peripheral portions must be relatively thin so as to facilitate securing of the headliner to the roof of the automobile.

Notwithstanding, the teachings of Kornylo there is significant room for improvement. For example, Komylo does not teach or suggest a vehicular headliner which can be regarded as an energy management device. While Komylo does teach the use of a reinforcing layer at the A-surface of the headliner this does not confer energy management properties to the headliner. Specifically, as is known in the art, the use of a reinforcing layer at the impact surface of the foam renders the impact surface harder and does note necessarily confer energy dissipation properties to the foam body.

Further, the process taught by Kornylo is disadvantageous since it is a requirement to spray the entire surface of the mold with varying amounts of foamable composition depending on the thickness of the finished part in the area being sprayed. Specifically, Komylo teaches that, during the process, foamable material is sprayed such that a greater amount of foamable material per unit area will generally be applied to central portions of the part relative to the amount of foamable material per unit area applied to peripheral portions of the part, the foamable material being applied to the different areas in amounts generally commensurate with a desired thickness of the headliner assembly at the different areas. Apparently, this results in apart having a substantially uniform density. The disadvantages accruing from this approach include the requirement to spray the entire surface of the mold (i.e., this has a deleterious affect on the overall efficiency of the assembly line) and the spraying mechanism is relatively-complicated since it must dispense varying amounts of foamable material depending on the area of the part being sprayed.

There is a developing need for headliners which possess energy management properties. Ideally, the energy management properties would obviate or mitigate injury to an occupant of the vehicle upon impact of the headliner by the occupant (i.e., compared to conventional headliners having little or energy management properties).

It would be preferable if a vehicular headliner having energy management properties could be manufactured in a moulding process. It would be even more preferable if the moulding process had desirable combination of efficiency and simplicity compared to the difficulties associated with the Kornylo process described above.

### SUMMARY OF THE INVENTION

It is an object of the present invention to provide a novel vehicular headliner which obviates or mitigates at least one of the above-mentioned disadvantages of the prior

It is another object of the present invention to provide a novel process for producing a vehicular headliner.

It is another object of the present invention to provide a novel mold for producing a vehicular headliner.

Accordingly, in one of its aspects, the present invention relates to a headliner comprising an A-surface disposed to face an interior of a vehicle and a B-surface substantially opposed to the A-surface, the headliner comprising a molded foam element having a substantially uniform density and an indentation force deflection at 25% deflection in the range of from about 150 pounds to about 4000 pounds when measured pursuant to ASTM 3574-B₁, the foam element comprising a peripheral portion, anon-peripheral portion and an intermediate portion disposed therebetween, the intermediate portion having a greater cross-sectional thickness than at least one of the peripheral portion and the non-peripheral portion.

In another of its aspects, the present invention relates to a process for producing a headliner in a mold comprising a first mold half and a second mold half engagable to define a mold cavity, the process comprising the steps of:

(i) placing a first cover material in the first mold half;

(ii) applying a-vacuum to the first mold half such that the cover material substantially assumes a shape of the first mold half;

(iii) dispensing a liquid foamable polymeric composition on a portion of a surface of one of the first mold half and the second mold half;

(iv) closing the first mold half and the second mold half;

(v) expanding the liquid foamable polymeric composition to fill substantially the mold cavity to produce the headliner.

In another of its aspects, the present invention provides a mold for producing a vehicular headliner, the mold comprising:

a first mold half and a second mold half releasably engagable between an open position and closed position to define a mold cavity in the closed position;

a seal disposed on at least one of the first mold half and the second mold half such that in the closed position of the mold, a substantially fluid tight seal is created between the mold cavity and an exterior thereof;

a vacuum chamber interposed between the seal and the mold cavity, the vacuum chamber having a cross-sectional thickness which allows entry of gases produced during expansion of a liquid foam composition in the mold cavity but which prevents entry of the liquid foam composition;

at least one ribbon vent interposed between the vacuum chamber and the mold cavity, the at least one ribbon vent comprising a passageway having a cross-sectional thickness which causes the liquid foam composition to enter the passageway.

### BRIEF DESCRIPTION OF THE DRAWINGS

Embodiments of the present invention will be described with reference to the accompanying drawings, in which:

FIG. 1 illustrates a perspective view of an embodiment of the present mold;

FIG. 2 illustrates an enlargement of a part-line vent disposed in the mold illustrated in FIG. 1;

FIG. 3 illustrates a sectional view taken along line III-III in FIG. 2;

FIG. 4 illustrates a sectional view taken along line IV-IV in FIG. 2;

FIG. 5 illustrates aspects of the present process;

FIG. 6 illustrates a perspective view of an embodiment of the present vehicular headliner; and

FIG. 7 illustrates a schematic view of placement of the headliner in relation to occupants in a vehicle.

### DETAILED DESCRIPTION OF THE PREFERRED EMBODIMENTS

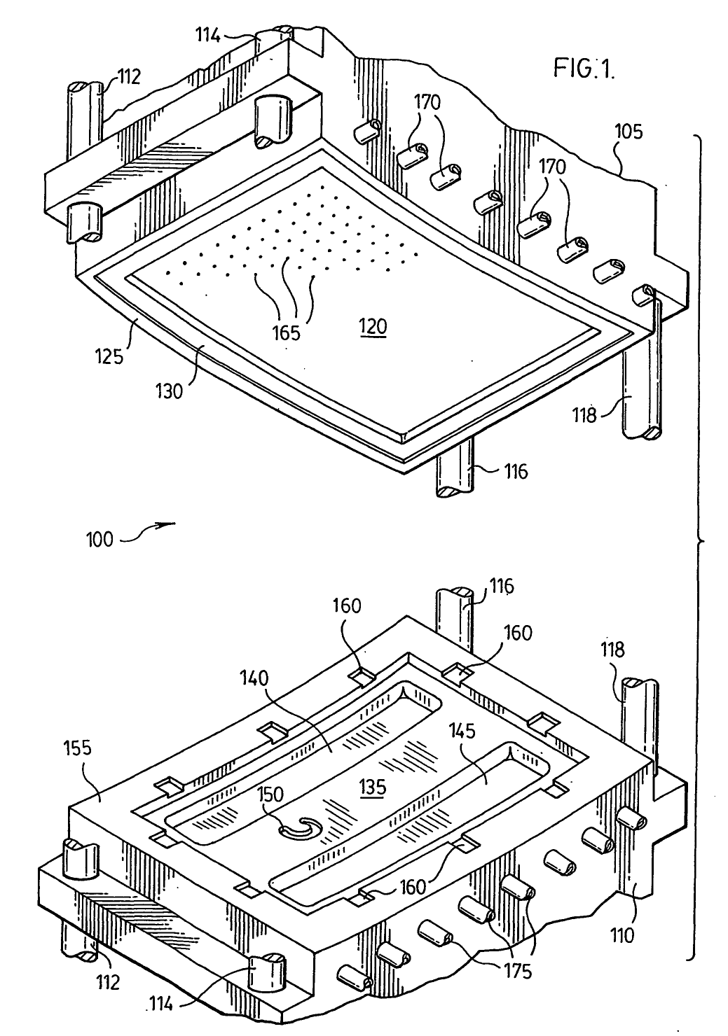

With reference to FIG. 1, there is illustrated a mold 100 comprising a lid 105 and a bowl 110. Lid 105 and bowl 110 are interconnected by four guiderails 112,114,116,118.

As will be appreciated by those of skill in the art, mold 100 is not a so-called “clam shell” mold where a lid and a bowl are engagable by pivoting near the part line of the mold. Rather, in the case of mold 100, the open and closed positions of the mold are achieved by appropriate upward (i.e., to open the mold) or downward (i.e., to close the mold) movement of lid 105 via guiderails 112,114,116,118. The relative movement between lid 105 and bowl 110 can be achieved by any suitable means (not shown).

In the illustrated embodiment, bowl 110 will shape and form the B-surface of the vehicular headliner whereas lid 105 will form and shape the A-surface of the vehicular headliner. Of course, if desired, this arrangement could be reversed.

With continued reference to FIG. 1, lid 105 comprises a mold surface 120 which is designed to assume the shape of the A-surface of the finished vehicular headliner. Disposed within mold surface 120 are a plurality of apertures 165 (for clarity, only some of the apertures are illustrated). A fluid impermeable seal 125 (e.g., a rubber bumper, a foam bead or the like) is disposed on the periphery of lid 105. As will be evident, seal 125 is substantially continuous about the perimeter of a surface of lid 105. A part-line surface 130 is interposed between mold surface 120 and seal 125.

Bowl 110 comprises a mold surface 135. Mold surface 135 comprises a pair of troughs 140,145 disposed generally longitudinally and adjacent to an edge of mold surface 135. Mold surface 135 also comprises a plurality of apertures 165 (for clarity, only some of the apertures are illustrated). Interposed between troughs 140,145 is a form 150.

A part-line surface 155 is disposed on bowl 110. A plurality of grooves 160 are disposed in part-line surface 155.

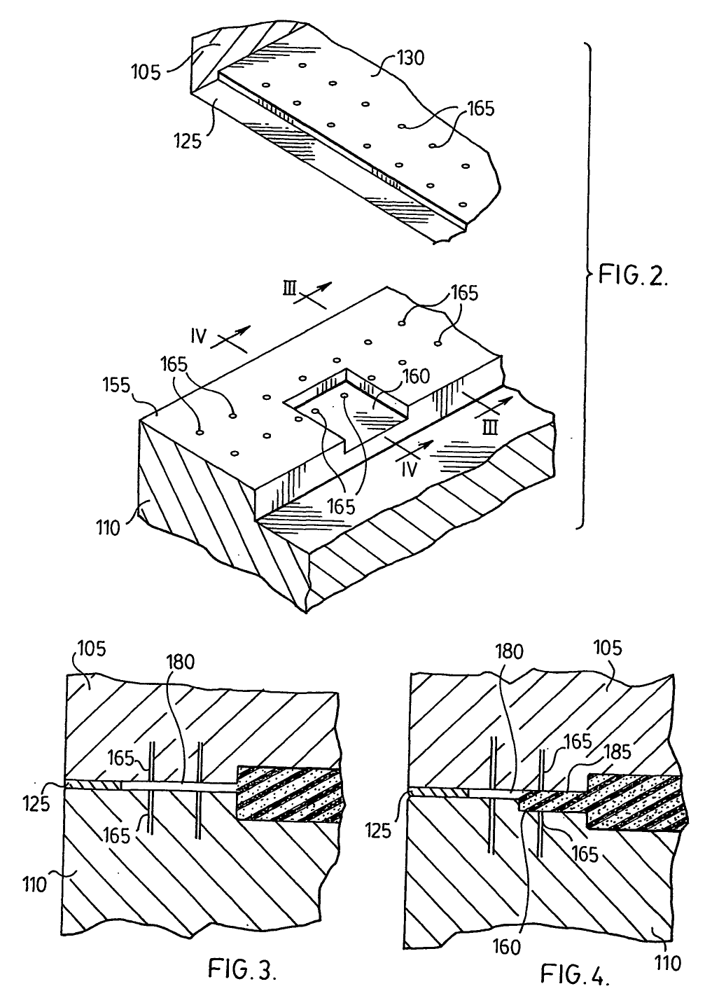

With reference to FIG. 2, there is illustrated an enlarged view of a peripheral portion of each of lid 105 and bowl 110 of mold 100. As shown, each of part-line surfaces 130,155 comprise a plurality of apertures 165. Apertures 165 are also disposed in grooves 160.

Apertures 165 are in communication with a chamber (not shown) within lid 105. Emanating from this chamber are a series of hoses 170 which are connected to a vacuum source (not shown). Similarly, apertures 165 disposed in bowl 110 are in communication with a chamber(not shown) within bowl 110. Emanating from this chamber are a series of hoses 175 which are connected to a vacuum source (not shown). As will be appreciated by those of skill in the art, it is possible to connect hoses 170 and hoses 175 to a common vacuum source (not shown) or independent vacuum sources (not shown).

With further reference to FIG. 2, it will be seen that seal 125 is in substantial alignment with a marginal edge of part-line surface 155 of bowl 110 which does not comprise apertures 165.

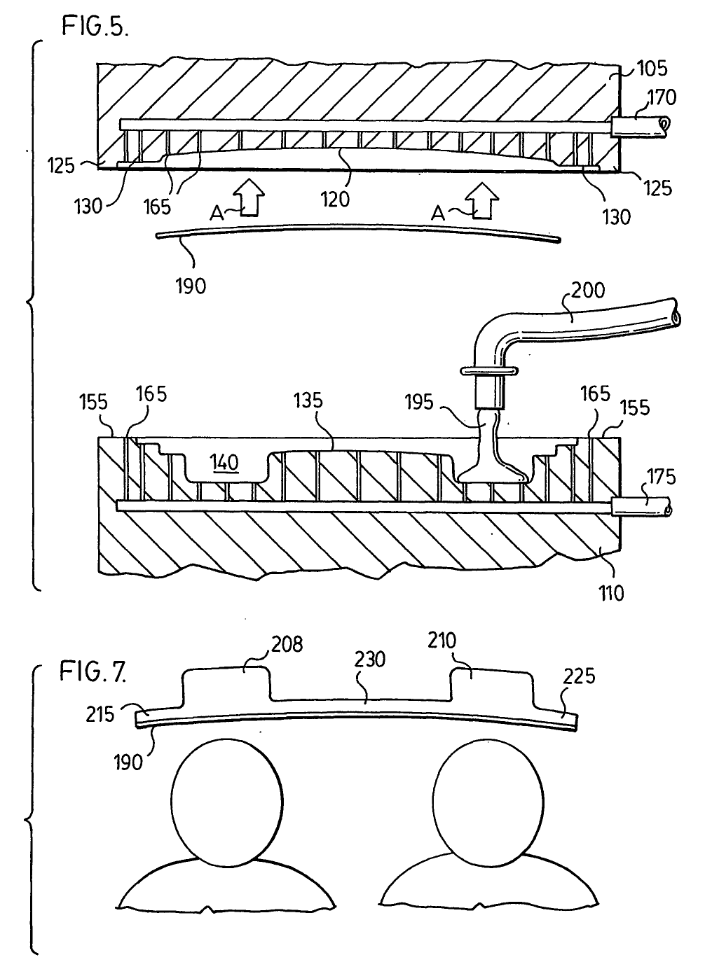

With brief reference to FIGS. 3 and 4, it will be seen that, when lid 105 and bowl 110 are closed, two types of vent passageways are defined.

In FIG. 3, seal 125 serves to define a so-called differential vent 180 formed between part-line surfaces 130,155. In FIG. 4, in addition to a differential vent 180, a so-called ribbon vent 185 is formed between part-line surface 130 and the major face of groove 160.

Preferably, ribbon vent 185 comprises a cross-sectional thickness in the range of from about 0.002 inches to about 0.030 inches, more preferably in the range of from about 0.005 inches to about 0.020 inches. The design of the vent component is described in more detail in U.S. Pat. Nos. 5,356,580 Re.36,413),5,482,721 (Re.36,572), and 5,587,183 [Clarke et al]. As set out the Clarke et al patents, the ribbon vent is sized to allow entry of some foamable material (this will be discussed in more detail hereinbelow).

Differential vent 180 preferably has a cross-sectional thickness of less than about 0.002 inches. A vent of this size generally will allow venting of gases produced during the foaming reaction but is sufficiently small to inhibit substantially foam extrusion into the vent. In this manner, the vent acts as a differential vent allowing passage of gas, but inhibiting passage of foam.

The operation of mold 100 will now be discussed.

With reference to FIG. 5, various steps in the present process are illustrated in a single Figure for clarity-purposes. Of course, those of skill in the art will recognize that it is not necessary to conduct all of the steps simultaneously (although this could be done if convenient).

Thus, the vacuum source (not shown) attached to hoses 170 is turned on thereby creating a sucking motion through apertures 165 in lid 105. At this point, a cover stock material 190 is disposed in lid 105 in the direction of arrows A.

The nature of cover stock 190 is not particularly restricted. Preferably, cover stock 190 comprises a laminate structure having a first outer layer and an inner layer. The first outer layer may be substantially permeable to air or substantially impermeable to air. Those of skill in the art will recognize that the first outer layer is adjacent mold surface 120 of lid 105 and the inner layer faces the mold cavity. The inner layer can comprise a cellular material or a non-cellular material or, in some cases, can be omitted entirely.

The vacuum source (not shown) connected to hoses 175 is turned on thereby creating a sucking effect through apertures 165 in bowl 110. It is preferred, at this point to apply a scrim or other layer over mold surface 135 of bowl 110. The purpose of such a layer is to obviate or mitigate plugging of apertures 165 in bowl 110 by foam material which is poured into bowl 110. The sucking effect created by the vacuum will shape the scrim or other layer to mold surface 135.

Next, a liquid foamable composition 195 is dispensed from a dispensing head 200. It will be recognized that composition 195 may be sprayed or poured. Preferably, composition 195 is poured in troughs 140,145. It is not necessary to dispense composition 195 over the entire surface of mold surface 135.

Once the appropriate amount of composition 195 has been dispensed into bowl 110, lid 105 and bowl 110 are closed. By continuing to apply a vacuum through all of apertures 165 in lid 105 and bowl 110, it will be recognized that, whereas apertures 165 on mold surfaces 120,135 are covered and the vacuum is used to hold the covering materials in place, apertures 165 disposed on part-line surfaces 130,155 act in combination to form an intermediate vacuum chamber around the perimeter (i.e., a perimeter differential vent) of the mold cavity defined by closing lid 105 and bowl 110. This intermediate vacuum chamber serves to facilitate venting of gases produced during the foaming reaction and distribution of the foam to substantially fill the mold cavity.

With reference to FIGS. 3 and 4, such venting serves to migrate the foam composition into ribbon vent 185 but not into differential vent 180. This vacuum-assisted venting facilitates proper filling of the mold cavity without the requirement of applying a foamable composition over the entire surface of mold surface 135.

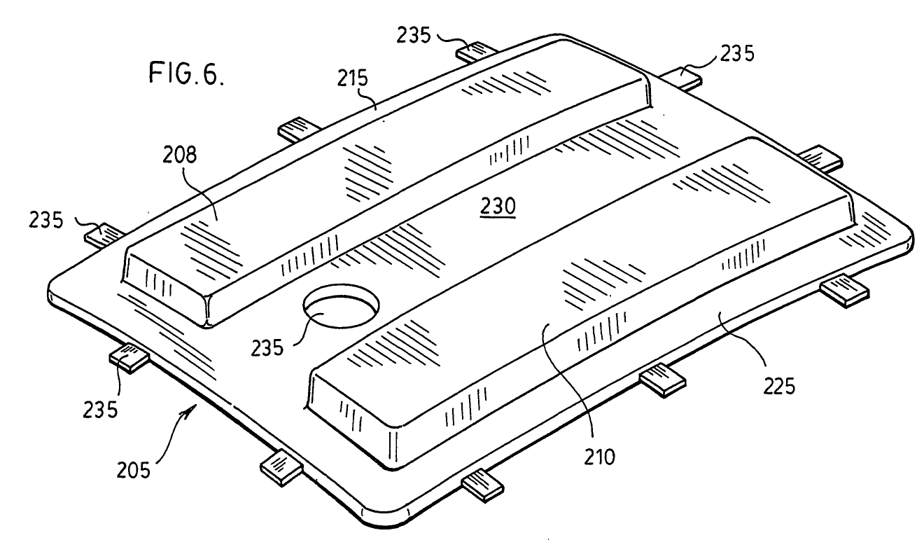

After foamable composition 195 expands and fills the mold cavity defined by closure of lid 105 and bowl 110, the mold is opened and a vehicular headliner 205 is de-molded (see FIG. 6). With reference FIG. 6, headliner 205 comprises a pair of longitudinally extending energy management portions 208,210 which are disposed longitudinally and adjacent a peripheral longitudinal edge of headliner 205. As is evident, energy management portions 208,210 are thicker in cross section than marginal portions 215,225. Further, energy management sections 205,210 are thicker in cross section than a central portion 230 of headliner 205. Disposed in central portion 230 is an aperture 235 which is produced by cutting out a portion of headliner weakened by form 150 in bowl 110 of mold 100.

As shown in FIG. 6, headliner 205 comprises a plurality of ribbons 235 which correspond to portions of foam which entered ribbon vent 185. If the foam composition used in the process is an energy management foam composition, it is preferred to trim ribbon portions 235 from the periphery of headliner 205. This can be achieved by any conventional means.

After production of headliner 205, the foam element therein has an indentation force deflection at 25% deflection in the range of from about 150 to about 4,000 pounds, more preferably from about 500 to about 2500 pounds, most preferably from about 900 to about 2000 pounds, when measured pursuant to ASTM 3574-B₁.

It will be appreciated by a person skilled in the art that it is only the foam element of the headliner of the present invention which is made of foam, preferably polyurethane foam, and it is this foam which should meet the ASTM test recited in the previous paragraph.

After expansion of the liquid foamable composition 195, the resultant foam is preferably a polyurethane foam. The polyurethane foam preferably has a specific gravity of less than about 0.40, more preferably in the range of from about 0.0.25 to about 0.25, preferably from about 0.10 to about 0.25. The preferred embodiment of foamable composition 195 comprises a liquid foamable polyurethane composition 195 having a free rise density of from about one to about twenty pounds per cubic foot, more preferably from about two to about eight pounds per cubic foot. For most mold foams, this would give use to a foam core having a density in the range of from about 1.5 to about 24 pcf, more preferably from about 2.5 to about 12 pcf.

Non-limiting and preferred examples of suitable polyurethane foams for use in producing the present headliner are available from Woodbridge Foam Corporation under the tradename Enerflex.

Generally, the polyurethane foam suitable for use in the present headliners and having desirable energy management characteristics may be produced from the following general non-limiting formulation:

| Component | Amount | |
|---|---|---|
| Polymer Polyol | 100-0 | parts |
| Polyol | 0-100 | parts |
| Crosslinker | 0-30 | parts/100 parts total polyol |
| Catalyst | 0.05 to 3.5 | parts/100 parts total polyol |
| Silicone Surfactants | 0-1.5 | parts/100 parts total polyol |
| H₂O | 0.5 to 4.5 | parts/100 parts total polyol |

| | |
|---|---|
| Isocyanate | Adequate quantity for an index of from |
| | about .60 to 1.30 ratio of NCO equivalents to |
| | the equivalents of NCO reactive sites. |

Suitable polymer polyols, polyols and isocyanates are described in U.S. Pat. Nos. 3,304,273, 3,383,351, 3,523,093, 3,939,106 and 4,134,610, Belgian patent 788,115, Canadian Patent 785,835 and “Polymer/Polyols, a New Class of Polyurethane Intermediate”, Kuryla, W. C. et al., J. Cellular Plastics, March (1966).

Suitable crosslinkers, catalysts and silicone surfactants are described in U.S. Pat. Nos. 4,107,106 and 4,190,712.

The preferred polyurethane foam suitable for use in the present head liner may be produced from the following formulation:

| Component | Amount |
|---|---|
| Polymer Polyol¹ | 20-100 parts |
| Polyol² | 0-80 parts |
| Crosslinker³ | 5-15 parts/100 parts total polyol |
| Catalyst⁴ | 0.5-1.2 parts/100 parts total polyol |
| Silicone Surfactants⁵ | 0.3-1.1 parts/100 parts total polyol |
| H₂O | 1.75-2.75 parts/100 parts total polyol |
| Isocyanate⁶ | Adequate quantity for an index of from about |
| | 0.8 to 1.1 ratio of NCO equivalents to the |
| | equivalents of NCO reactive sites. |

¹ Bayer E-850
² 5000 MW propylene oxide adduct of glycerine with 75% primary capping
³ BASF 953
⁴ DABCO R-8020
⁵ Goldschmidt B-4113
⁶ Dow Chemical Company PAPI 27

With reference to FIG. 7, a very schematic illustration is provided of placement of headliner 205 with reference to the location of occupants in a vehicle. Such a headliner can be designed to possess advantageous energy management properties thereby obviating or mitigating injuries to the occupants upon impact of the occupants and headliner 205.

While a specific embodiment of producing the present headliner has been shown with reference to the Figures, those of skill in the art will recognize that a number of modifications to the specific embodiment can be made without departing from the spirit and scope of the present invention. For example, the use of form 150 on mold 135 in the illustrated embodiment is optional and thus, may be omitted (e.g., if a dome light is not to be attached to the finished headliner). Still further, the design of troughs 140,145 can vary depending on factors such as the specific vehicle in the headliner is to be used, the specific requirements for the headliner in that vehicle and the like. For example, it is not necessary that the troughs continuous and longitudinal as illustrated. Still further, in some cases, it may be desirable to heat mold 100 during expansion of foamable composition 195 (e.g., depending on the chemical composition of foamable composition 195. In such cases, hoses 170,175 may be used for this purposes and the vacuum applied to apertures 165 may be generated from other hoses, conduits and the like (not shown). Still further, it is possible to utilize a cover stock 190 having a cloth outer layer and a plastic inner layer and couple the use of such a cover stock with a post-production step of piercing or otherwise rendering breathable the inner layer of the cover stock. This can be achieved by any suitable means such as by using a plurality of needles applied to the cover stock of the finished part thereby piercing the inner layer interposed between the foam element and the finished cover. Alternatively, it is possible to utilize a cover stock comprising a finished outer layer and an inner layer which will disintegrate or otherwise become air permeable after production of the headliner. Still further, it is possible to include in the cover stock a layer of material which will confer advantageous sound absorbing properties to the resultant headliner. The use of such a layer would obviate the need to increase the thickness of the foam (as suggested by Komylo) to achieve advantageous sound absorbing properties. An example of such a sound absorbing layer could be polyester fibre mat, melamine-based foam, GC (density and permeability controlled flexible polyurethane) foam and the like applied to the finished cover stock material. Further, reinforcing layers or chopped fibre can be used at the surface of or disposed within the foam element to provide appropriate reinforcement, where necessary. Of course, the mold illustrated above can be modified to allow insertion of design components (e.g. clips, dome lights, wiring harnesses and the like) during production. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A headliner (205) comprising an A-surface disposed to face an interior of a vehicle and a B-surface substantially opposed to the A-surface, the headliner (205) dimensioned to line a vehicular roof and comprising a molded foam element having a substantially uniform density and au indentation force deflection at 25% deflection in the range of from about 150 pounds to about 4000 pounds when measured pursuant to ASTM 3574-B₁, the foam element comprising a peripheral portion (215,225), a non-peripheral portion (230) and an intermediate portion (208,210) disposed therebetween, the intermediate portion (208,210) having a greater cross-sectional thickness than at least one of the peripheral portion (215,225) and the non-peripheral portion (230).

2. The headliner defined in claim 1, wherein the foam element comprises an indentation force deflection at 25% deflection in the range of 500 to about 2500 pounds, when measured pursuant to ASTM 3574-B₁.

3. The headliner defined in claim 1, wherein the foam element comprises an indentation force deflection at 25% deflection in the range of 900 to about 2000 pounds, when measured pursuant to ASTM 3574-B₂.

4. The headliner deed in any one of claims 1-3, wherein the foam element comprises an isocyanate-based polymer foam.

5. The headliner defined in any one of clam 1-3, wherein the foam element comprises polyurethane foam.

6. The headliner defined in ally one of claims 1-5, wherein the headliner further comprises a cover material (190) adjacent the A-surface and fixed with respect to the foam element.

7. The headliner defined in clan 6, wherein the cover material comprises a laminate structure comprising a first outer layer and an inner layer.

8. The headliner defined in claim 7, wherein the first outer layer is substantially permeable to air.

9. The headliner defined in claim 7, wherein the first outer layer is substantially non-permeable to air.

10. The headliner defined in any one of claims 7-9, wherein the inner layer comprises a cellular material.

11. The headliner defined in any one of claims 7-9, wherein the intermediate layer comprises a noncellular material.

12. The headliner defined in any one of claims 1-11, wherein the intermediate portion has a greater cross-sectional thickness than the peripheral portion.

13. The headliner defined in any one of claims 1-11, wherein the intermediate portion has a greater cross-sectional thickness than the non-peripheral portion.

14. The headliner defined in any one of claims 1-11, wherein the intermediate portion has a greater cross-sectional thickness than both the peripheral portion and the non-peripheral portion.

15. The headliner defined in any one of claims 1-14, further comprising a second outer layer adjacent the B-surface.

16. The headliner defined in claim 15, wherein the second outer layer is substantially impermeable to air.

17. The headliner defined in claim 15, wherein the second outer layer comprises a polymer film.

18. A process for producing a headliner as defined in claims 1, in a mold comprising a first mold half (105) and a second mold half (110) engagable to define a mold cavity, the process comprising the steps of:
(i) placing a first cover material (190) in the first mold half (105);
(ii) applying a vacuum to the first mold half (105) such that the first cover material (190) substantially assumes a shape of the first mold half (105);
(iii) dispensing a liquid foamable polymeric composition (195) on a portion of a surface of one of the first mold half (105) and the second mold half (110);
(iv) closing the first mold half (105) and the second mold half (110);
(v) expanding the liquid foamable polymeric composition (195) to fill substantially the mold cavity to produce the headliner (205).

19. The process defined in claim 18, comprising the further step of:
(vi) applying a vacuum to the mold cavity during Step (v).

20. The process defined in any one of claims 18-19, wherein Step (iii) comprises dispensing the liquid foamable polymeric composition (195) on a portion of a surface of the second mold half (110), and Step (v) comprises expanding the liquid foamable polymeric composition (195) in a direction substantially toward the first mold half (105).

21. The process defined in claim 20, wherein, prior to Step (iii) a second cover material is placed in the second mold half (110).

22. The process defined in claim 21, comprising the fix step of applying a vacuum to the second mold half (1 10) such that the second cover material substantially assumes a shape of the second mold half (110).

23. The process defined in any one of claims 21-22, wherein the second cover is selected from materials which are substantially impermeable to air.

24. The process defined in any one of claims 21-22 wherein the second cover is selected from a group comprising polymer films.

25. The process defined in any one of claims 18-24, wherein Step (iii) comprises dispensing the liquid foamable polymeric composition (195) on a portion of a surface of the cover material (190) disposed on the first mold half (105).

26. The process defined in any one of claim 18-25, wherein the fist cover material is selected from laminate structures comprising a first outer layer and an inner layer.

27. The process defined in claim 26, wherein the first outer layer is selected from materials which are permeable to air.

28. The process defined in claim 26, wherein the first outer layer is selected from materials which are non-permeable to air.

29. The process defined in any one of claims 26-28, wherein the inner layer is selected from cellular materials.

30. The process defined in any one of claims 26-28, wherein the inner layer is selected from non-cellular material.

31. The process defined in any one of claims 26-30, wherein the inner layer is selected from materials which are non-permeable to air.

32. The process defined in claim 31, con sing the further step, after Step (v), of perforating the inner layer.

33. A mold for prod a vehicular headliner (205) as defined in any one of claims 1-17, the mold (100) comprising:
a first mold half (105) and a second mold half( 110) releasably engagable between an open position and closed position to define a mold cavity in the closed position;
a seal (125) disposed on at least one of the first mold half (105) and the second mold half (110) such that in the closed position of the mold (100), a substantially fluid tight seal is created between the mold cavity and an exterior thereof;
a vacuum chamber interposed between the seal and the mold cavity, the vacuum chamber having a cross-sectional thickness which allows entry of gases produced during expansion of a liquid foam composition in the mold cavity but which prevents entry of the liquid foam composition;
at least one ribbon vent (185) interposed between the vacuum; chamber and the mold cavity, the at least one ribbon vent comprising a passageway having a cross-sectional thickness which causes the liquid foam composition to enter the passageway.
